(19) United States
(12) Patent Application Publication
(10) Pub. No.: US 2024/0255862 A1
(43) Pub. Date: Aug. 1, 2024

(54) PRINTER

(71) Applicant: Hewlett-Packard Development Company, L.P., Spring, TX (US)

(72) Inventors: Vitaly PORTNOY, Nes Ziona (IL); Dror KELLA, Nes Ziona (IL); Michel ASSENHEIMER, Nes Ziona (IL); Yuval KFIR, Nes Ziona (IL)

(73) Assignee: Hewlett-Packard Development Company, L.P., Spring, TX (US)

(21) Appl. No.: 18/290,652

(22) PCT Filed: Jul. 22, 2021
(86) PCT No.: PCT/US2021/042808

§ 371 Date: Jan. 19, 2024

(51) Int. Cl. G03G 15/01; G03G 15/10

(52) U.S. Cl. CPC G03G 15/0189; G03G 15/104; G03G 2215/0122

(57) ABSTRACT

In one example, a printing process includes gathering a first group of individual color separations for an image sequentially on an intermediate transfer roller, transferring the first group from the intermediate transfer roller to a printable substrate, gathering a second group of individual color separations for the image sequentially on the intermediate transfer roller, and transferring the second group from the intermediate transfer roller to the substrate.

### BACKGROUND

Liquid electro-photographic (LEP) printing uses a special kind of ink to form images on paper and other printable substrates. LEP ink contains tiny pigments encapsulated in a polymer resin, forming particles that are dispersed in a carrier liquid. The polymer particles are sometimes referred to as toner particles and, accordingly, LEP ink is sometimes called liquid toner. In an LEP printing process, an electrostatic pattern of the desired printed image is formed on a photoconductor for each color separation of the image. Each latent color separation is developed by applying a thin layer of LEP ink to the patterned photoconductor. Polymer particles in the ink adhere to the electrostatic pattern on the photoconductor. The ink color separations are transferred sequentially from the photoconductor to a heated intermediate transfer roller, evaporating carrier liquid and melting the polymer particles, and then pressed on to the cooler substrate and “frozen” in place at a nip between the intermediate transfer roller and the substrate.

### DRAWINGS

FIG. 1 is a block diagram illustrating one example of an LEP printer configured to print a color image by transferring groups of two color separations individually to a printable substrate.

FIGS. 2-7 are block diagrams illustrating an example printing operation using the LEP printer shown in FIG. 1.

FIG. 8 is a detail from FIG. 7.

FIG. 9 is an isometric illustrating another example of an LEP printer configured to print a color image by transferring groups of two color separations individually to a printable substrate.

FIGS. 10 and 11 are block diagrams illustrating an example printing operation using the LEP printer shown in FIG. 9.

FIG. 12 is a detail from FIG. 11.

FIG. 13 is a flow diagram illustrating one example of a printing process such as might be implemented by an LEP printer in FIGS. 1 and 9.

The same part numbers refer to the same or similar parts throughout the figures. The figures are not necessarily to scale.

### DESCRIPTION

LEP printers use a process in which each ink color separation developed on the photoconductor is transferred individually from the photoconductor to an intermediate transfer roller (ITR) and then individually from the ITR to a sheet of paper or other printable substrate. The substrate is wrapped on a roller that is pressed against the ITR to transfer each color separation to the substrate. For an image printed with four color separations, CMYK (cyan, magenta, yellow and black) for example, the substrate interacts with the ITR four times to sequentially gather all four color separations. For an image printed with seven color separations, CMYKOPG (cyan, magenta, yellow, black, orange, purple, and green) for another example, the substrate interacts with the ITR seven times to gather the seven color separations. This process is sometimes referred to as a “multi-shot” process (e.g., “4 shot” or “7 shot”) because the color separations are transferred individually from the ITR to the substrate where they are gathered sequentially to form the printed image.

One of the challenges implementing a multi-shot process is accurately aligning each successive color separation to the previous separation(s), commonly referred to as “color plane registration.” In addition, the edges of the substrates repeatedly pressed against the surface of the ITR eventually wears out the ITR. A “one shot” process in which all of the two, three, four or more color separations are gathered on the ITR and then transferred to the substrate as a single, composite has been used to help minimize color plane registration errors and extend the life of the ITR by decreasing the number of interactions between the substrate and the ITR. In a one shot process, however, the color separations undergo a varying degree of heating and drying according to the amount of time each resides on the ITR. Consequently, the color separations in one shot printing may not adhere to the printable substrate as well as the color separations in multi-shot printing. The substrates used in one shot printing, therefore, are usually pre-treated with a primer that improves adhesion but adds cost and limits the type of substrates that may be used to print high quality images.

A new LEP printing process has been developed to improve color plane registration with no significant loss of adhesion on unprimed substrates compared to conventional multi-shot printing. In one example, the new process includes gathering a first group of two individual color separations sequentially on the ITR, transferring the first group from the ITR to an unprimed substrate, gathering a second group of two individual color separations sequentially on the ITR, and transferring the second group from the ITR to the substrate. For printing an image with an even number of color separations greater than four, the gathering and transferring are repeated until all color separations are transferred to the substrate. For printing an image with an odd number of color separation greater than four, the process includes transferring a single color separation from the ITR to the substrate before, between, or after gathering and transferring groups of two color separations.

Examples of the new process may be implemented by an LEP printer configured to print a color image by transferring at least one group of two color separations individually to a printable substrate.

The inventors have shown that, for printing an image with four color separations, gathering and transferring two groups of two color separations improves color plane registration by about 30% with no significant loss of adhesion on unprimed substrates compared to conventional multi-shot printing, and that the reduced number substrate/ITR engagements nearly doubles the life of the ITR.

These and other examples shown in the figures and described below illustrate the claimed subject matter but do not limit the scope of the patent, which is defined by the Claims following this Description.

As used in this document: “and/or” means one or more of the connected things; a “computer readable medium” means any non-transitory tangible medium that can embody, contain, store, or maintain programming for use by a computer processor and may include, for example, circuits, integrated circuits, ASICs, hard drives, random access memory (RAM), and read-only memory (ROM); and “LEP ink” means a liquid that includes polymer particles in a carrier liquid suitable for electro-photographic printing.

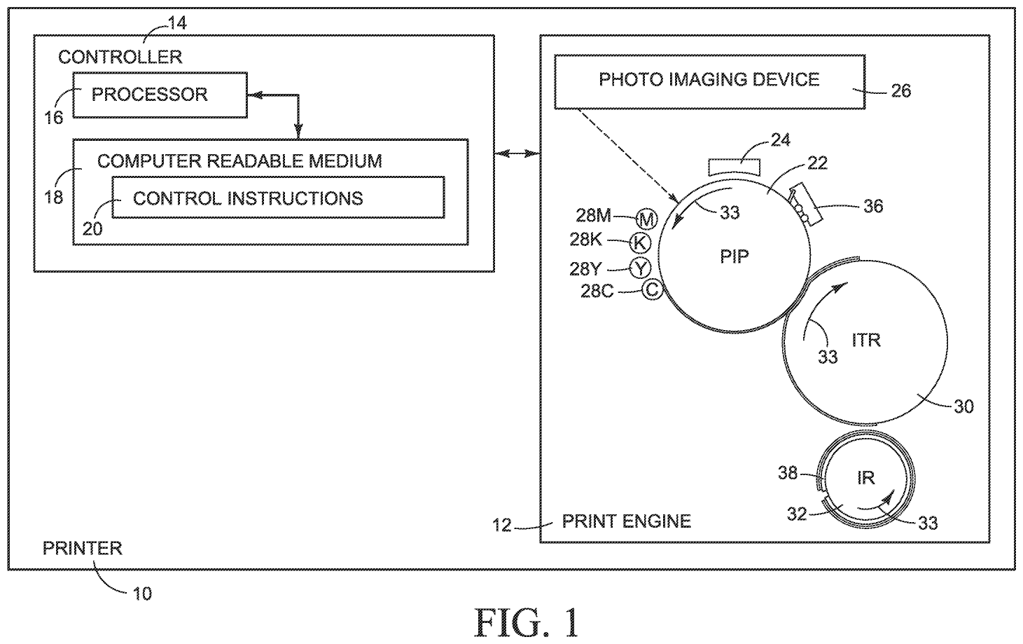

FIG. 1 is a block diagram illustrating one example of an LEP printer 10 configured to print a color image by transferring groups of two color separations individually to a printable substrate. Referring to FIG. 1, printer 10 includes a print engine 12 and a controller 14 operatively connected to print engine 12. Controller 14 includes the programming, processing and associated memory resources, and the other electronic circuitry and components to control the operative elements of printer 10. Controller 14 may include distinct control elements for individual systems and components of printer 10 including print engine 12. In particular, controller 14 in FIG. 1 includes a processor 16 and a computer readable medium 18 with control instructions 20 operatively connected to processor 16.

Print engine 12 in FIG. 1 includes a photoconductor roller 22, a scorotron, charge roller or other suitable charging device 24, a scanning laser, LED array, or other suitable photo imaging device 26, developer rollers 28M, 28K, 28Y, and 28C, an intermediate transfer roller 30, and an impression roller 32. A photoconductor roller 22 in an LEP printer is commonly referred to as a “photo imaging plate” (PIP) even though it is not flat. Although four developer rollers 28M, 28K, 28Y, and 28C to print a color image using magenta (M), black (K), yellow (Y), and cyan (C) color separations are shown in FIG. 1, more or fewer developer rollers and/or for different colors could be used. The direction of rotation for each roller 22, 30, and 32 is indicated by arrows 33 in the figures.

For each color separation used to print an image, charging device 24 forms a uniform electric charge on the surface of the rotating photoconductor roller 22 and, as photoconductor roller 22 continues rotating, photo imaging device 26 illuminates selected areas on the surface of photoconductor roller 22 to alter the surface charge in a pattern of dots representing an individual one of the color separations. A thin layer of LEP ink applied to photoconductor roller 22 by the corresponding developer roller 28M, 28K, 28Y, or 28C adheres to the pattern of dots to “develop” the color separation. Each color separation developed on photoconductor roller 22 is transferred individually to intermediate transfer roller 30 in the desired sequence by direct contact and under the influence electrostatic forces between rollers 22 and 30. Ink residue may be removed from photoconductor roller 22 at a cleaning station 36 in preparation for developing the next color separation.

The individual color separations are gathered on intermediate transfer roller 30 in groups of two and each group of two color separations is transferred individually to a printable substrate 38 wrapped on impression roller 32. In FIG. 1, a first group of two color separations has been transferred to substrate 38 and a second group two color separations is being gathered on intermediate transfer roller 30.

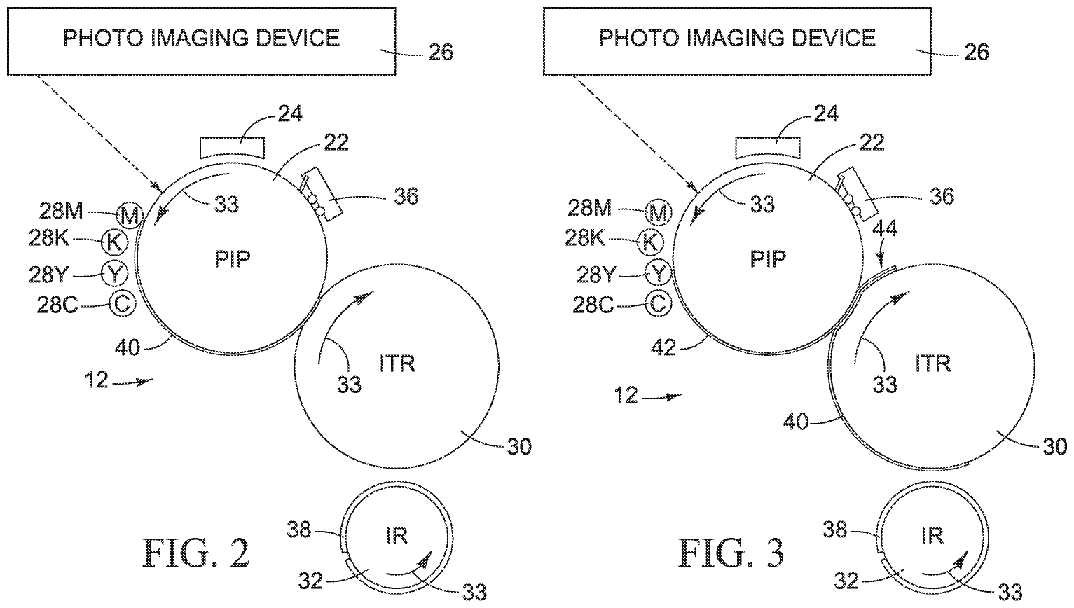

FIGS. 2-7 are block diagrams illustrating an example printing operation using an LEP printer 10 shown in FIG. 1. The thickness of each color separation is greatly exaggerated in the figures. Also, to more clearly illustrate a printing sequence, each color separation is depicted as a layer of ink that overlaps the adjacent layer(s). Each color separation is actually an array of tiny dots that may or may not overlap dots in the adjacent color separation(s).

In FIG. 2, the first, magenta separation 40 developed on photoconductor roller 22 is being transferred to intermediate transfer roller 30 and photo imaging device 26 is patterning photoconductor roller 22 for the next color separation. Substrate 38 on impression roller 32 is disengaged from intermediate transfer roller 30. In FIG. 3, the second, yellow separation 42 developed on photoconductor roller 22 is being transferred to intermediate transfer roller 30 and gathered together with magenta separation 40 in a first group 44 of two color separations as photo imaging device 26 is patterning photoconductor roller 22 for the next color separation. Substrate 38 on impression roller 32 is disengaged from intermediate transfer roller 30 in FIGS. 2 and 3 as color separations 40, 42 gather together on roller 30 as a first group 44 of two color separations.

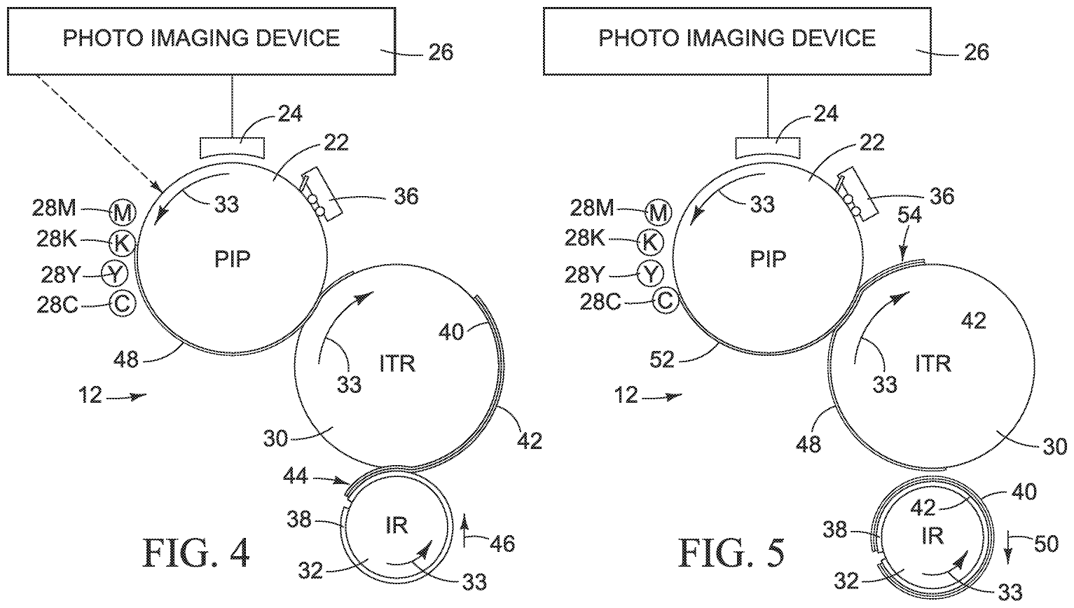

In FIG. 4, impression roller 32 has been moved in to engage substrate 38 against intermediate transfer roller 30, as indicated by arrow 46, to transfer the first group 44 of color separations 40, 42 from roller 30 to substrate 38. A heated blanket that forms the exterior surface of intermediate transfer roller 30 makes thermal contact with the ink in each color separation 40, 42 to evaporate carrier liquid and melt polymer particles in the LEP ink. The resulting molten ink on roller 30 adheres to the cooler substrate 38 at the nip between rollers 30, 32 to effect the transfer of color separations 42, 40 from roller 30 to substrate 38. The third, black separation 48 developed on photoconductor roller 22 is being transferred to intermediate transfer roller 30 and photo imaging device 26 patterns photoconductor roller 22 for the last color separation in this sequence.

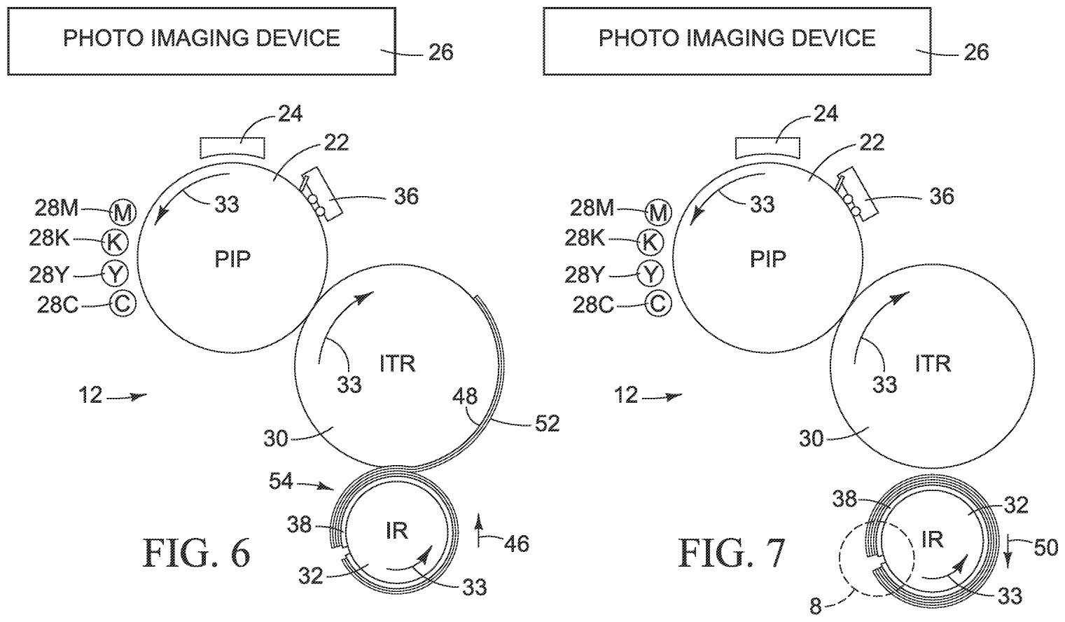

In FIG. 5, impression roller 32 has been moved away to disengage substrate 38 from intermediate transfer roller 30, as indicated by arrow 50, the fourth, cyan separation 52 developed on photoconductor roller 22 is being transferred to intermediate transfer roller 30 and gathered together with black separation 48 in a second group 54 of two color separations 48, 52. In FIG. 6, impression roller 32 has been moved in to engage substrate 38 against intermediate transfer roller 30 and transfer second group 54 of color separations 52, 48 from roller 30 to substrate 38.

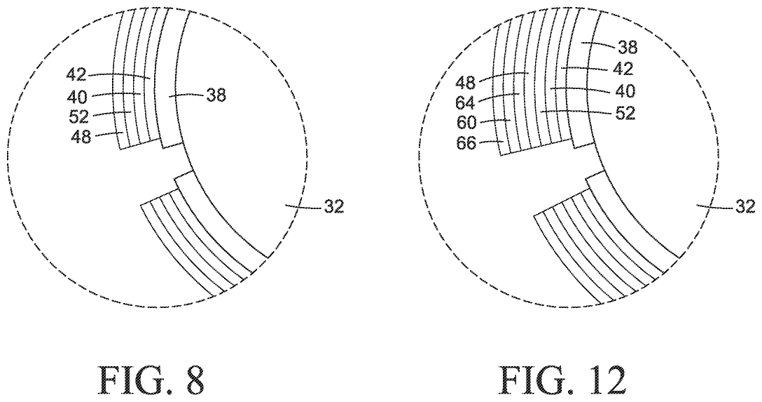

In FIG. 7, impression roller 32 has been moved away to disengage substrate 38 from intermediate transfer roller 30. Referring also to the detail of FIG. 8, substrate 38 with a printed image formed with all four color separations 42, 40, 52, 48 may then be released from impression roller 32.

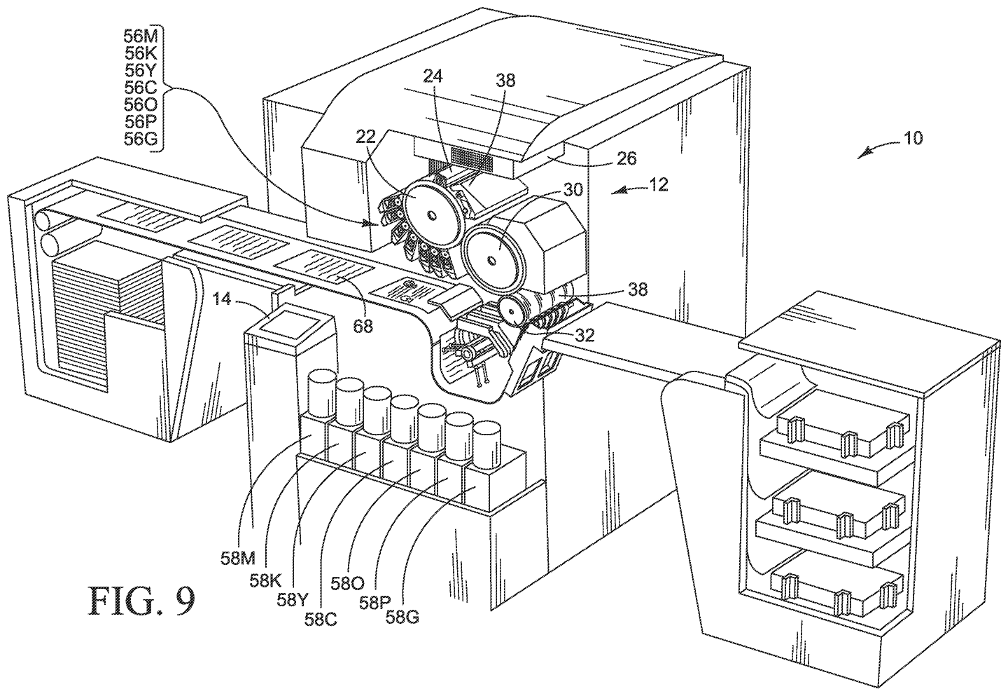

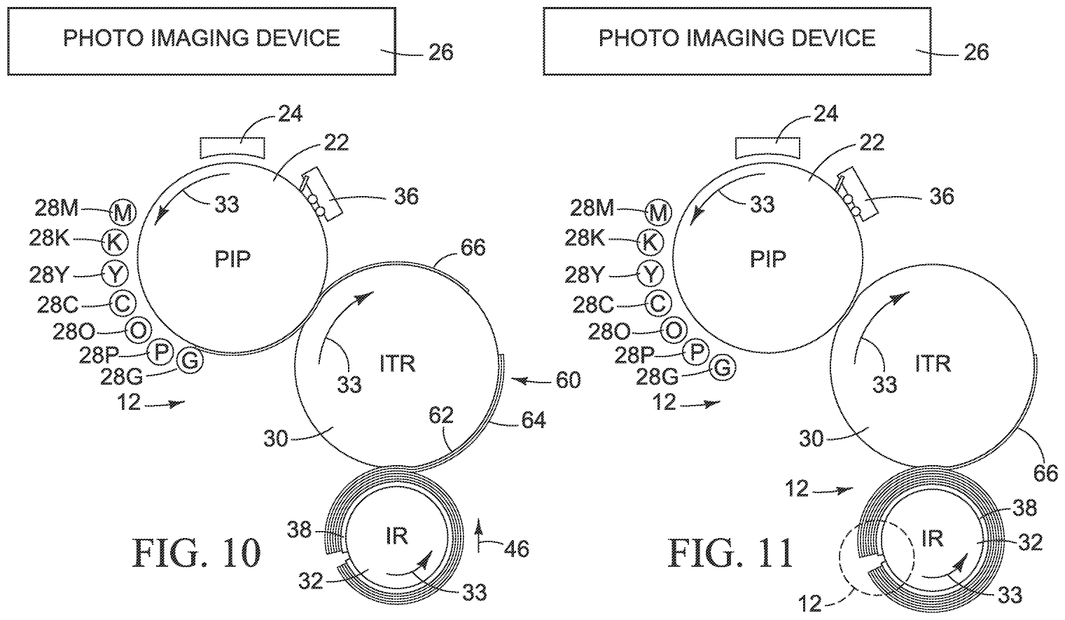

FIG. 9 is an isometric view illustrating one example of an LEP printer 10 configured to print a color image by transferring groups of two color separations individually to a printable substrate. FIGS. 10 and 11 are block diagrams illustrating an example printing operation using the LEP printer 10 shown in FIG. 9. Referring to FIGS. 9-11, printer 10 includes a print engine 12 and a controller 14 operatively connected to print engine 12. Controller 14 includes the programming, processing and associated memory resources, and the other electronic circuitry and components to control the operative elements of printer 10. Controller 14 may include distinct control elements for individual systems and components of printer 10 including print engine 12. Controller 14 in FIG. 9 may include a processor 16 and a computer readable medium 18 with control instructions 20 operatively connected to processor 16 as shown in FIG. 1.

Print engine 12 includes a photoconductor roller 22, a charging device 24, a photo imaging device 26, developer units 56M, 56K, 56Y, 56C, 560, 56P, and 56G each with a developer roller 28M, 28K, 28Y, 28C, 280, 28P, and 28G called out in FIG. 10, an intermediate transfer roller 30, and an impression roller 32. Printer 10 in FIG. 9 also includes LEP ink supplies 58M, 58K, 58Y, 58C, 580, 58P, and 58G to supply ink to a corresponding developer unit 56M, 56K, 56Y, 56C, 560, 56P, and 56G.

In FIG. 10, four of seven color separations have been transferred to substrate 38 in groups of two color separations as described above with reference to FIGS. 2-7, for example yellow, magenta, cyan, and black color separations 42, 40, 52, and 48. Impression roller 32 has been moved in to engage substrate 38 against intermediate transfer roller 30 to transfer a third group 60 of two color separations 62, 64 gathered on roller 30 to substrate 38. The last color separation 66 in the sequence developed on photoconductor roller 22 is being transferred to intermediate transfer roller 30. In this example, the fifth color separation 62 is orange, the sixth color separation 64 is purple, and the seventh color separation 66 is green.

In FIG. 11, the last, green color separation 66 is being transferred individually from intermediate transfer roller 30 to substrate 38 to complete the printed image. Referring also the to the detail of FIG. 12, substrate 38 with a printed image formed with all seven color separations 40, 42, 48, 52, 62, 64, and 66 may then be released from impression roller 30 and discharged from print engine 12 as a printed sheet 68 in FIG. 9.

The order in which the color separations are transferred to the substrate may affect print quality. For example, in a conventional multi-shot process with four color separations, each separation is transferred individually yellow, magenta, cyan and then black (Y-M-C-K). As shown in FIGS. 2-7, the same effect is achieved by reversing the order in which the color separations in each group are transferred from photoconductor roller 22 to intermediate transfer roller 30—each separation is transferred to the intermediate transfer roller individually magenta, yellow, black, and cyan, (M-Y-K-C), gathered on the intermediate transfer roller in a first group 44 magenta then yellow (M/Y) and a second group 54 black then cyan (K/C), so that each group transferred individually to the substrate results in the desired order yellow, magenta, cyan and then black (Y-M-C-K). In general, for a multi-shot process with four color separations 1-2-3-4 for example, the same effect is achieved by reversing the order in each group—2/1 and then 4/3.

In the sequence shown in FIGS. 2-7, two groups of two color separations are transferred to print an image with four color separations. In the sequence shown in FIGS. 9 and 10, three groups of two color separations and one single color separation are transferred to print an image with seven color separations. To take full advantage of two color group transfers, it is expected that the printing sequence usually will transfer as many of the color separations as possible in groups of two, for example two groups for four color separations in FIGS. 2-7 and three groups for seven color separations in FIGS. 9 and 10. However, it may be desirable in some printing sequences to include one or multiple single color transfers for an even number of color separations and multiple single color transfers for an odd number of color separations.

Examples are not limited to printing images with four color separations as shown FIGS. 2-7 or seven color separations as shown in FIGS. 9 and 10. More of fewer color separations are possible. For example, an image with three color separations (e.g., CMY) may be printed with a group of two color separations and a single color separation transferred before or after the group. For another example, an image with five color separations (e.g., CMYKW) may be printed with two groups of two color separations and a single color separation transferred before, between, or after the groups.

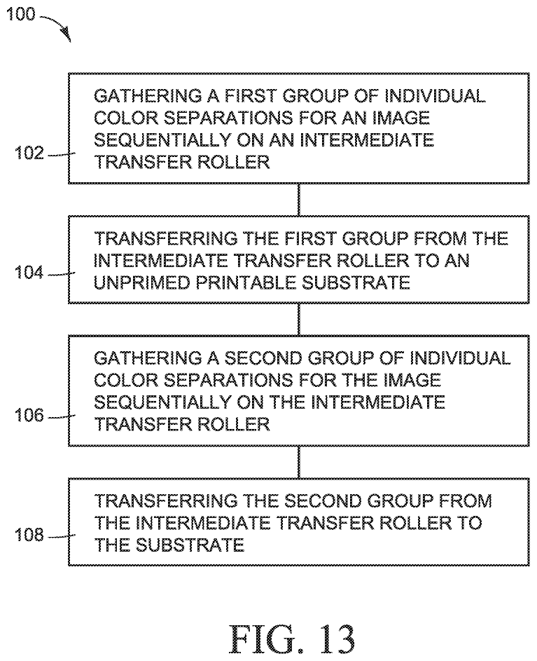

FIG. 13 illustrates one example of a printing process 100 such as might be implemented by a controller 14 in an LEP printer 10 in FIG. 1 executing control instructions 20. Referring to FIG. 11, process 100 includes gathering a first group of individual color separations for an image sequentially on an intermediate transfer roller (block 102), for example as shown in FIG. 3, transferring the first group from the intermediate transfer roller to an unprimed printable substrate (block 104), for example as shown in FIG. 4, gathering a second group of individual color separations for the image sequentially on the intermediate transfer roller (block 106), for example as shown in FIG. 5, and transferring the second group from the intermediate transfer roller to the substrate (block 108), for example as shown in FIG. 6.

In an example, for an image with an even number of color separations greater than four, the process includes repeating the gathering and transferring for one or more subsequent groups of color separations until all color separations for the image are transferred to the substrate. In an example, for an image having an odd number color separation greater than four, the process includes transferring a single color separation from the intermediate transfer roller to the substrate before gathering any of the groups, after transferring one group and before gathering the next group, or after transferring all of the groups.

“A” and “an” in the Claims means one or more. For example, “a group” means one or more groups and subsequent reference to “the group” means the one or more groups.

1. A printer configured to print a color image by transferring more than two color separations to a printable substrate including transferring a group of exactly two color separations individually to the substrate.

2. The printer of claim 1 configured to print the image by transferring each of multiple groups of exactly two color separations individually to the substrate.

3. The printer of claim 1 configured to print the image by:
transferring a group of exactly two color separations individually to the substrate; and
transferring a single color separation individually to the substrate.

4. A liquid electro-photographic printer, comprising:
a photoconductor roller;
an impression roller to carry a printable substrate wrapped on the impression roller;
an intermediate transfer roller to receive each of multiple color separations for an LEP ink image from the photoconductor roller and to transfer the color separations to a printable substrate wrapped on the impression roller; and
a controller operatively connected to the impression roller and programmed to cause a printable substrate wrapped on the impression roller to selectively engage and disengage the intermediate transfer roller to gather each of multiple groups of exactly two of the color separations on the intermediate transfer roller and transfer each group sequentially to the substrate.

5. The printer of claim 4, wherein the controller is programmed to cause the substrate wrapped on the impression roller to selectively engage the intermediate transfer roller to transfer one or more of the color separations individually from the intermediate transfer roller to the substrate.

6. The printer of claim 4, comprising:
a photo imaging device;
multiple developer rollers each to apply a different color LEP ink sequentially to the photoconductor roller; and wherein
the controller is operatively connected to the photo imaging device and the developer rollers and programmed to:
cause the photo imaging device to illuminate select areas of the photoconductor roller in a series of patterns each corresponding to one of the color separations; and
cause each of the developer rollers, respectively, to apply one of the different color LEP inks to the photoconductor roller with the corresponding pattern in the series to form a corresponding one of the color separations.

7. The printer of claim 4, comprising an unprimed printable substrate wrapped on the impression roller.

8. A printing process, comprising:
gathering a first group of individual color separations for an image sequentially on an intermediate transfer roller;
transferring the first group from the intermediate transfer roller to a printable substrate;
gathering a second group of individual color separations for the image sequentially on the intermediate transfer roller; and
transferring the second group from the intermediate transfer roller to the substrate.

9. The process of claim 8, wherein the first group includes exactly two color separations.

10. The process of claim 8, wherein:
the first group includes exactly two color separations; and
the second group includes exactly two color separations.

11. The process of claim 10, wherein:
gathering the first group comprises gathering a magenta separation and then a yellow separation; and
gathering the second group comprises gathering a black separation and then a cyan separation.

12. The process of claim 10, comprising, for an image having an even number of color separations greater than four, repeating the gathering and transferring for one or more subsequent groups of exactly two color separations until all color separations for the image are transferred to the substrate.

13. The process of claim 10, comprising, for an image having an odd number of color separations greater than four, transferring a single color separation from the intermediate transfer roller to the substrate before gathering the first group, after transferring the first group and before gathering the second group, and/or after transferring the second group.

14-19. (canceled)
